(19) United States
(12) Patent Application Publication
(10) Pub. No.: US 2025/0308878 A1
(43) Pub. Date: Oct. 2, 2025

(54) APPARATUS FOR ACCOMMODATING A SOLID SAMPLE MATERIAL

(71) Applicant: Technische Universität Wien, Wien (AT)

(72) Inventors: Andreas LIMBECK, Wien (AT); Egon Erwin ROSENBERG, Wien (AT); Johannes FRANK, Klosterneuburg (AT); Laura KRONLACHNER, Wien (AT)

(21) Appl. No.: 18/698,733

(22) PCT Filed: Oct. 4, 2022
(86) PCT No.: PCT/EP2022/077583

§ 371 Date: Oct. 1, 2024

(30) Foreign Application Priority Data
Oct. 5, 2021 (AT) A50791/2021

(51) Int. Cl. H01J 49/16; H01J 49/00

(52) U.S. Cl. CPC H01J 49/164; H01J 49/0031

(57) ABSTRACT

The invention relates to an apparatus for accommodating and for analysing, in a spatially and depth-resolved manner, a solid sample material, the apparatus comprising a substantially gas-tight sealed housing (1) with a sample-accommodating region (2) arranged inside the housing (1), the housing (1) comprising a window (3) that is transparent to a laser beam, the apparatus having an inlet device (4) for introducing a fluid flow into the sample-accommodating region (2), and a first outlet device (5) and a second outlet device (6) for discharging the fluid flow, loaded with removed sample material, from the sample-accommodating region (2), the outlet devices (5, 6) being formed in such a way that the ratio between the fluid flow volume flows exiting from the first outlet device (5) and the fluid flow volume flows exiting from the second outlet device (6) is from 100:1 to 5000:1, in particular from 500:1 to 2000:1.

The present invention relates to an apparatus for accommodating and for analysing a solid sample material in a spatially and depth-resolved manner and a system comprising such an apparatus, a laser apparatus and optionally a mass spectrometric apparatus. The invention further relates to a method for analysing a solid sample material using an apparatus according to the invention.

The increasing use of materials or coatings based on organic compounds in industry (e.g. polymer materials or paints and varnishes) but also in many areas of everyday life (e.g. foils and packaging materials) requires reliable characterisation of the used substances. Information on the chemical composition of solid sample materials is particularly necessary for issues relating for example to plastics processing, damage analysis or plastics recycling.

Established and well-known standard methods of organic analysis such as liquid chromatography or gas chromatography coupled with mass spectrometric detection allow access to this information, but their application is subject to significant disadvantages. The solid sample material must be prepared before the actual analysis, i.e. in particular it must be dissolved or in the form of a volatile or gaseous compound. This means additional work steps that are not only time-consuming, but also potential sources of error. In addition, information about the exact localisation of analytes is lost during sample preparation, so that usually only information about the average composition of the sample material can be obtained. However, a spatially resolved analysis would be useful for many issues.

In order to avoid the disadvantages associated with sample preparation, methods are known that allow direct analysis of organic material in solid samples. Examples of this are infrared spectroscopy and various laser-based methods of organic mass spectrometry. Compared to the classic approaches described above, these methods do not require any complex sample preparation, so that a significantly higher sample throughput is generally possible.

However, even the latter methods for the direct analysis of solid sample materials are often inadequate, particularly with regard to the accessible analytes, the spatial resolution and the possibility of carrying out depth-resolved analyses. However, enabling depth-resolved analysis is a particularly important aspect, as the analytical characterisation of sample materials with layered structures has significantly gained in importance in recent years.

In contrast to the analysis of organic compounds, different analytical methods are already used in the field of elemental analysis for the investigation of depth profiles. Examples include glow discharge mass spectrometry (GD-MS), secondary ion mass spectrometry (SIMS) or laser-based methods such as laser-induced breakdown spectroscopy (LIBS) or laser ablation in conjunction with inductively coupled plasma mass spectrometry (LA-ICP-MS). However, such methods do not allow the receipt of compound-specific information.

Due to its destructive nature, laser-based analysis is well suited for spatially and depth-resolved analysis with achievable resolutions in the μm range. Laser-material interaction is used to ablate solid sample material, which is then transported to the analysis device in the form of extremely fine particles by means of a fluid flow. The spatial and depth resolution depends, among other things, on the laser apparatus used, but the behaviour and transport of the ablated solid sample material are also significant.

In this respect, the flow rate of the fluid flow is of great importance, which in the case of LA-ICP-MS, for example, is usually in the range of a few litres per minute. The mass spectrometric apparatuses used for elemental analysis are compatible with such high flow rates. If such a system were to be coupled with a mass spectrometric apparatus for organic and molecular analysis, the high fluid throughput would not be suitable for an analysis with sufficient sensitivity; the flow rate would have to be reduced, which would, however, worsen the leaching behaviour of the ablated solid sample material and thus reduce the spatial and depth resolution, resulting in a conflict of objectives.

It is therefore an object of the present invention to resolve the conflict of objectives described above and to provide an apparatus which can be used for direct spatially and depth-resolved analysis of solid sample material, and which allows molecular information to be obtained or used with a mass spectrometric apparatus suitable for organic and molecular analysis.

In particular, the apparatus according to the invention should therefore be suitable for use with a mass spectrometric apparatus with electron impact ionisation under vacuum conditions, since particularly valuable molecular information can be obtained with such a mass spectrometric approach. However, the apparatus according to the invention can be used with another suitable form of ionisation.

These and further objects are solved by an apparatus having the features of the independent patent claim.

The present invention relates to an apparatus for accommodating and for analysing a solid sample material, in particular for laser-based chemical analysis, comprising a substantially gas-tight sealed housing with a sample-accommodating region arranged inside the housing, wherein the housing comprises a window that is transparent to a laser beam, wherein the apparatus has an inlet device for introducing a fluid flow into the sample-accommodating region and a first outlet device and a second outlet device for discharging the fluid flow loaded with ablated sample material from the sample-accommodating region.

According to the invention, it may be provided that the outlet devices are configured in such a way that the ratio between the volume flows of the fluid flow exiting from the first outlet device and volume flows of the fluid flow exiting from the second outlet device is from 100:1 to 5000:1, in particular from 500:1 to 2000:1.

It was found in the context of the present invention that the use of two outlet devices and the division of the fluid flow make it possible to pass high volume flows through the sample-accommodating region and still allow the solid sample material ablated by the laser beam to be analysed in a mass spectrometric device for organic analysis. On the one hand, the high volume flows on the inlet side can achieve good leaching behaviour of ablated solid sample material from the sample-accommodating region; on the other hand, the fluid flow loaded with sample material exiting from the second outlet device can be analysed in a mass spectrometric apparatus that is only suitable for the introduction of low volume flows.

In one specific embodiment, the fluid flow is a gas flow, preferably a helium flow. However, depending on the application purpose, other gases or mixtures of two or more gases can also be used. A liquid can also be used.

Optionally, it is provided that the inlet device is configured to introduce a fluid flow to the sample-accommodating region, in particular a gas, preferably helium, at a flow rate of between 0.5 L/min and 5 L/min, in particular between 0.5 L/min and 2 L/min. Optionally, these flow rates may be present at a pressure between 0.5 bar and 2 bar. Preferred flow rates are between 0.8 L/min and 2.0 L/min, in particular between 1.2 L/min and 1.8 L/min. These fluid parameters enable particularly good leaching behaviour. In particular, the sample-accommodating region can have an internal volume of less than or equal to 5 cm³, in particular less than or equal to 2 cm², preferably less than or equal to 1 cm³.

Optionally, it is provided that the housing has an inlet opening to which the inlet device is connected, in that the housing has a first outlet opening to which the first outlet device is connected, and in that the housing has a second outlet opening to which the second outlet device is connected. The arrangement of inlet and outlet openings in the housing enables a particularly efficient division of the fluid flow.

Optionally, it is provided that a main flow direction of the fluid flow runs between the inlet opening and the first outlet opening, and in that the second outlet opening is arranged at an angle α between 10° and 90°, in particular between 30° and 60°, in relation to the main flow direction. In particular, the first outlet opening can be arranged exactly opposite the inlet opening. The main part of the fluid flow then flows through the sample-accommodating region in an essentially linear manner and the smaller volume flow, which is diverted to the second outlet opening, flows at an angle α away from the main flow direction.

Optionally, it is provided that the sample-accommodating region is circular or drop-shaped. This enables good leaching behaviour, which is similar over the entire sample-accommodating region.

Optionally, it is provided that the first outlet device has a length L₁ and a flow cross-section Q₁, and that the second outlet device has a length L₂ and a flow cross-section Q₂. Optionally, the outlet devices each comprise outlet tubes with the specified length and the specified flow cross-section.

The lengths of the outlet devices run in particular from the respective outlet opening in the housing to an outlet end of the outlet device. In particular, the end of the second outlet device can be connected to a mass spectrometric apparatus. Optionally, the end of the first outlet device can also be connected to an analysis apparatus, in particular to a mass spectrometric apparatus or to an emission spectroscopic apparatus.

The lengths L₁ and L₂ thus indicate in particular the distance through which a fluid flow can or does flow in the respective outlet device. If the flow cross-section is not constant over the entire length of the outlet device, the flow cross-sections mentioned can each indicate the smallest flow cross-section along the path of an outlet device.

Optionally, the volume flow (V₂) exiting from the second outlet device is defined by the length (L₂) and the cross-sectional area (Q₂) of the second outlet device. In particular, this also determines the division ratio of the total volume flow (V₀) supplied via the inlet device.

This volume flow can be described by Hagen-Poisseuille's law, which according to equation 1 is as follows:

$${V}_{2} = \frac{π {r}^{4} Δ p}{8 η l} \qquad Equation 1$$

This includes: V₂ . . . volume flow exiting the second outlet device; r . . . radius of the second outlet device; Δp . . . pressure drop across the second outlet device (=initial pressure minus final pressure); η . . . dynamic viscosity of the fluid; l . . . length of the second outlet device.

The division ratio V₁/V₂ of the gas flow supplied via the inlet device is determined from the two volume flows V₁ and V₂ according to equation 2:

$${V}_{1} = {V}_{0} - {V}_{2} \qquad Equation 2$$

In particular, assuming a sufficiently large outlet for the volume flow V₁, the length and flow cross-section of the second outlet device determine the pressure drop on this side. This allows the ratio of the partial volume flows exiting from both outlet devices to be determined.

Optionally, it is therefore provided that the first outlet device has essentially no pressure drop, in particular for volume flows of less than 2 L/min, the fluid preferably being a gas, particularly preferably helium. “Essentially no pressure drop” means in particular that the final pressure is less than 1% below the initial pressure.

Preferably, it is provided that the housing has no further outlet opening from which the fluid can escape in other than the first outlet opening and the second outlet opening. Apart from the inlet opening and the two outlet openings, the housing can therefore be configured to be essentially fluid-tight, in particular gas-tight.

Optionally, it is provided that the flow cross-section Q₂ is between 0.003 and 0.12 mm².

Optionally, it is provided that the inlet device comprises an inlet tube.

Optionally, it is provided that the housing is arranged on a movement device which is configured to translationally move the housing, in particular in three directions which are essentially orthogonal to one another. This allows the position of the solid sample material in relation to the laser beam to be changed to enable ablation at different points on the sample material.

Optionally, it is provided that the second outlet device comprises a heating device which is configured to heat the second outlet device at least sectionally. In particular, the heating device can further be configured to heat the fluid in the second outlet device and any ablated sample material contained therein. This can reduce the risk of condensation of ablated sample material inside the second outlet device. It was found that by using the heating device, the leaching behaviour of the apparatus and thus also the peak shape of the mass spectrometric signals can be improved.

Optionally, it is provided that the heating device is configured to heat the second outlet device to a temperature of at least 70° C., in particular at least 100° C., at least sectionally.

The heating device can, for example, be configured as a heating jacket that at least partially surrounds the second outlet device.

The invention further relates to a system comprising an apparatus according to the invention, and a laser apparatus, wherein the laser apparatus is configured to emit a laser beam onto a solid sample material arranged in the sample-accommodating region.

Optionally, it is provided that the window has a transmittance of at least 80%, preferably at least 90%, for the wavelength of the laser beam. In particular, the window can comprise or consist of quartz glass or transparent corundum, such as sapphire glass.

Optionally, it is provided that the laser apparatus is configured to emit a pulsed monochromatic laser beam with a wavelength of less than 300 nm, and/or that the laser apparatus is configured to emit a focused laser beam with a minimum beam diameter of less than 500 μm, in particular less than 200 μm. In particular, the laser device can be configured to emit a laser beam with a wavelength of approximately 248 nm, 224 nm, 213 nm or 193 nm. The laser device can comprise a solid-state laser or a gas-phase laser.

Optionally, it is provided that the system further comprises a mass spectrometric apparatus, wherein the mass spectrometric apparatus is configured to ionise sample material in the fluid flow ablated by means of the laser beam by electron impact ionisation in a vacuum, wherein the mass spectrometric apparatus for accommodating the fluid flow is connected or connectable to the second outlet device. Optionally, the mass spectrometric device may alternatively or additionally be configured to ionise sample material in the fluid flow ablated by means of the laser beam by another suitable form of ionisation in a vacuum.

Optionally, the outlet end of the second outlet device is connected or can be connected to a sample insertion opening of the mass spectrometric apparatus.

Optionally, the mass spectrometric apparatus has an ion source which is configured for the Ionisation of the sample material, whereby the ion source has an electrode arrangement for the formation of an electric field. Optionally, the electrode arrangement has a cathode and an anode and the potential difference can be set in a range between 10 V and 100 V. Optionally, the ion source has a heating device, which is configured in particular to provide a temperature of between 100° C. and 300° C. in the ion source. Optionally, a pump device is provided in the mass spectrometric apparatus, which is configured to provide a pressure of less than 10⁻⁴ Pa, in particular less than 10⁻⁵ Pa, in the ion source.

Optionally, it is provided that an observation apparatus is provided for visual observation of the sample-accommodating region through the window, wherein the laser beam can preferably be guided or is guided through an optical system of the observation apparatus.

Optionally, it is provided that the observation apparatus comprises an emission analysis apparatus configured to analyse emission radiation generated upon interaction of the laser beam with a solid sample material. For this purpose, the observation apparatus may comprise, for example, an emission radiation collection device and a spectroscopic unit, the latter being configured to analyse the radiation collected by the emission radiation collection device.

Optionally, the system further comprises an analysis apparatus connected to the first outlet device. The analysis apparatus may be configured to chemically analyse sample material in the fluid flow that has been ablated by the laser beam. The analysis apparatus may be another mass spectrometric apparatus, for example, or an emission spectroscopic apparatus. Preferably, the analysis apparatus comprises an inductively coupled plasma into which the gas flow exiting from the first outlet device can be introduced. In this case, further analysis can be carried out by means of mass spectrometric detection and/or emission spectrometric detection. Optionally, the analysis apparatus is suitable for determining element information from the solid sample material.

The invention further relates to a method for analysing a solid sample material with an apparatus according to the invention. The method may comprise the following steps:
Placing the sample material in the sample-accommodating region,
Ablation of sample material by means of a laser apparatus,
Transporting the ablated sample material via a fluid flow flowing from the inlet device via the sample-accommodating region to the first outlet device and to the second outlet device, wherein the outflowing volume flows of the fluid flow are in a ratio of between 100:1 and 5000:1, in particular between 500:1 and 2000:1, between the first outlet device and the second outlet device,
Analysing the ablated sample material exiting together with the fluid flow from the second outlet device with a mass spectrometric apparatus which is configured to ionise the sample material by electron impact ionisation in a vacuum.

Optionally, the mass spectrometric device may alternatively or additionally be configured to ionise ablated sample material by another suitable form of ionisation in a vacuum.

Optionally, it is provided that the volume flow of the fluid flow flowing in through the inlet device is between 0.5 L/min and 5 L/min, in particular between 0.5 L/min and 2 L/min, optionally at a pressure of between 0.5 bar and 2 bar.

Optionally, it is provided that the volume flow of the fluid flow exiting through the second outlet device is less than 10 mL/min, in particular less than 5 mL/min, preferably between 0.25 and 2.5 mL/min.

Further features of the present invention become apparent from the patent claims, the figures and the description of the exemplary embodiment.

In the following, the present invention will be discussed in detail with reference to exemplary embodiments.

In the figures:

FIG. 1 shows a schematic perspective view of an apparatus according to the invention according to a first exemplary embodiment;

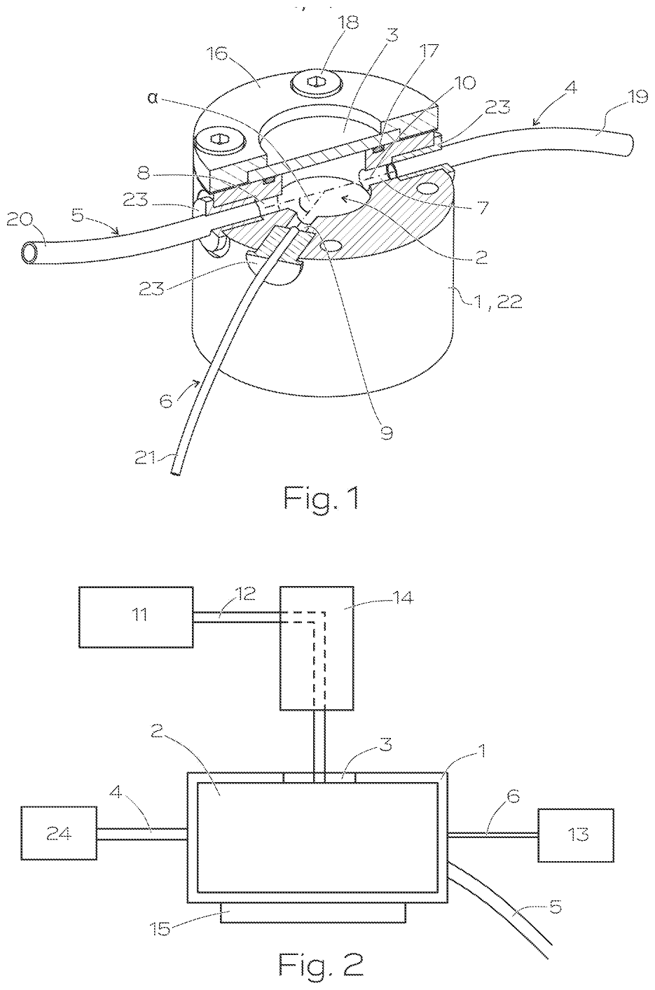

FIG. 2 shows a schematic view of a system comprising an apparatus according to the invention according to the first exemplary embodiment;

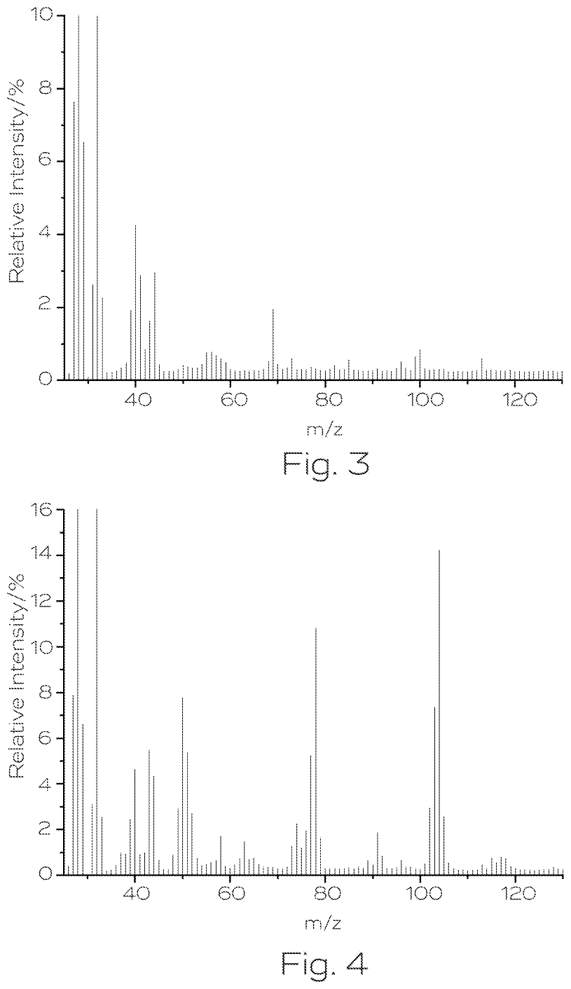

FIG. 3 shows an exemplary mass spectrum of polymethyl methacrylate; and

FIG. 4 shows an exemplary mass spectrum of polystyrene.

FIG. 1 shows a schematic perspective view of an apparatus according to the invention according to a first exemplary embodiment. The apparatus comprises a housing 1 with a sample-accommodating region arranged therein, which in this example is circular in top view. The housing 1 is formed by a cover 16 and a bottom housing part 22, the cover 16 being connected to the bottom housing part 22 via screws 18. The cover 16 comprises a window 3 that is transparent to laser radiation. In this exemplary embodiment, the window is made of quartz glass.

The housing has three openings, wherein an inlet opening 7, a first outlet opening 8 and a second outlet opening 9 are provided. Apart from the three openings, the housing 1 is configured to be gas-tight to the environment. An annular seal 17 is provided between window 3 and bottom housing part 22 for sealing.

An inlet device 4 is arranged at the inlet opening 7 and comprises a connector 23 and an inlet tube 19. A first outlet device 5 is arranged at the first outlet opening 8 and comprises a connector 23 and a first outlet tube 20. A second outlet device 9 is arranged at the second outlet opening 9 and comprises a connector 23 and a second outlet tube 21.

The inlet opening 7 and the first outlet opening 8 are arranged opposite each other. This means that the two openings 7, 8 are arranged along the main flow direction 10 of the gas flow. The second outlet opening 9 is laterally offset from the first outlet opening 8, with the angle α in relation to the main flow direction 10 being approximately 30° in this example.

If a gas flow is fed into the sample-accommodating region 2 via the inlet device 4, it can only flow out again from the sample-accommodating region 2 via the two outlet devices 5, 6. The outlet devices 5, 6 are configured in such a way that the volume flow that flows out via the first outlet device 5 and the second outlet device 6 is in a ratio of approximately 1000 to 1. This means that when a volume flow of approximately 1000 mL/min is introduced via the inlet device 4, approximately 1 mL/min exits from the second outlet device 6. The remaining gas flow exits via the first outlet device 5.

In the present exemplary embodiment, this division of the volume flows is determined by the corresponding choice of length and flow cross-section of the outlet devices 5, 6. The length of the outlet devices 5, 6 is the distance that a gas travels between the beginning and the end of the respective outlet device 5, 6.

The first outlet device 5 has a length L₁ of around 100 cm and a flow cross-section Q₁ of around 7 mm². The second outlet device 6 has a length L₂ of around 220 cm and a flow cross-section Q₂ of around 0.008 mm². If the diameter of the first outlet device 5 is sufficiently large, the volume flow in the second outlet direction 6 is substantially only determined by the length (L₂) and the cross-sectional area (Q₂) of this second outlet device 6. The division ratio can be controlled over a wide range (approx. 1:100-1:5000) by regulating the volume flow V₀ supplied to the sample-accommodating region 2 via the inlet device 4.

This ratio can be varied within certain limits depending on the respective requirements. If, for example, the length L₂ is reduced, this has a directly proportional effect on Q₂, which increases the ratio and thus also the volume flow exiting the second outlet device 6.

FIG. 2 shows a schematic view of a system comprising the apparatus according to the invention according to the first exemplary embodiment. Additionally, the system comprises a laser apparatus 11 and a mass spectrometric apparatus 13.

The inlet device 4 is connected to a gas tank 24 in order to be able to introduce gas into the sample-accommodating region 2.

In this exemplary embodiment, the laser apparatus 11 comprises a pulsed nanosecond solid-state laser. The laser device 11 generates a laser beam 12 with a wavelength of 266 nm. The laser beam 12 is guided through the window 3, which is made of quartz glass, into the sample-accommodating region 2. The optical manipulation of the laser beam 12 takes place in the observation apparatus 14, which further comprises a microscope system for observing the sample-accommodating region 2. The section of the sample-accommodating region 2 to which the laser beam 12 is directed can always be observed by means of this arrangement.

The optical system of the observation apparatus 14 can be used to adjust the cross-section of the laser beam 12 in the sample-accommodating region 2 or on the surface of the solid sample material (not shown). In this exemplary embodiment, the cross-section can be variably adjusted between 10 μm and 200 μm.

In this system, the housing 1 of the apparatus according to the invention is arranged on a movement device 15, which is configured as a motorised platform and can translationally move the housing 1 in three spatial directions. This allows the relative position between the solid sample material and the laser beam 12 to be adjusted.

In the system shown herein, the first outlet device 5 opens into an exhaust (not shown), where the exiting gas is fed for cleaning and disposal. The gas that escapes from the first outlet device 5 is therefore not used any further. In an example, however, this gas could also be analysed further. For example, the end of the first outlet device 5 may be connected to another mass spectrometric apparatus, such as an ICP-MS device. The end of the first outlet device 5 may alternatively be connected to another analysis apparatus, for example to an emission spectroscopic apparatus such as an ICP-OES apparatus. By connecting the first outlet device 5 to a further analysis apparatus, information about the elemental composition of the solid sample material can also be obtained, for example.

The second outlet device 6 opens into the mass spectrometric apparatus 13, which is configured as an apparatus with electron impact ionisation under vacuum conditions. The mass spectrometric apparatus 13 comprises an ionisation chamber to which the end of the second outlet device 6 is connected and into which the exiting gas flow flows. The features of such an apparatus are well known in the art and will not be explained in detail here. The mass spectrometric apparatus 13 can have another suitable form of ionisation as an alternative to or in addition to electron impact ionisation.

The analysis of a solid sample material with a system from FIG. 2 can be carried out as follows:

The solid sample material is placed in the sample-accommodating region 2 of the apparatus, the housing 1 is closed and purged with gas from the gas tank 24, which flows into the sample-accommodating region 2 at approximately 1000 mL/min via the inlet device 4. Due to the described division of the volume flows, approximately 1 mL/min of this gas flow exits from the second outlet device 6 and flows into the mass spectrometric apparatus 13. The remaining gas flow exits through the first outlet device 5.

A position on the surface of the solid sample material intended for analysis is now selected via the observation apparatus 14 and the laser beam 12 is focused on this position; the selected position is irradiated with the laser beam 12. The introduced energy causes ablation of sample material, which means that solid sample material in the form of particles and gaseous products is transferred into the gas space. The ablation cloud generated locally at the position of the laser ablation is transported by the gas flow to the outlet devices 5, 6 and a portion of the ablated sample material passes through the second outlet device 6 to the mass spectrometric apparatus 13, where the solid sample material, or more precisely the aerosol of the solid sample material, is analysed.

Mass spectra obtained using the system of FIG. 2 are shown as examples in FIGS. 3 and 4. In the graphs shown in FIGS. 3 and 4, m/z values are plotted on the X-axis, while the Y-axis shows relative intensity values. m/z values indicate the mass-to-charge ratio of detected ions.

FIG. 3 shows a mass spectrum obtained by analysing polymethyl methacrylate as a solid sample material. Electron impact ionisation in the mass spectrometric apparatus 13 generates fragment ions that are characteristic of the analysed sample material. Exemplary characteristic fragment ions in FIG. 3 have the m/z values 41, 55, 69 and 100.

FIG. 4 shows a mass spectrum obtained by analysing polystyrene as a solid sample material. Electron impact ionisation in the mass spectrometric apparatus 13 generates fragment ions that are characteristic of the sample material being analysed. Exemplary characteristic fragment ions in FIG. 4 have the m/z values 51, 78, 91 and 102, 104 and 117.

The characteristic fragment ions can be used to identify the solid sample material, for example by comparing it with reference tables or databases.

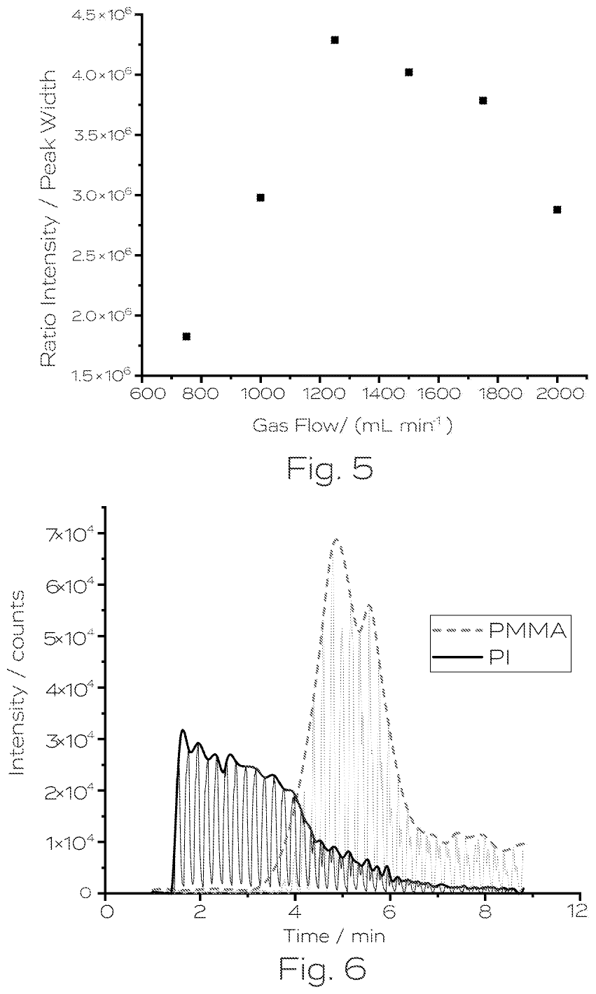

In the context of the present invention, variations were further made to the system of FIG. 2 with regard to the gas flow flowing in through the inlet device 4. FIG. 5 shows the relationship between the intensity of the total ion current (TIC) during ablation of a polymethyl methacrylate sample and the width of the obtained peak. The intensity is an important parameter with regard to the sensitivity of the analysis, while the peak width reflects the leaching behaviour of the apparatus. FIG. 5 shows that the ratio reaches a maximum at around 1200 mL/min. This means that the apparatus has the highest performance at this gas flow.

Further, a two-layer sample with an upper layer of polyimide and a lower layer of polymethyl methacrylate was analysed using the system shown in FIG. 2. The point of impact of the laser beam 12 or the laser pattern was not changed during this analysis, making it possible to obtain a depth profile of the sample material. The intensity curves of the peaks at m/z values 51, 74 and 98 (representative of polyimide) and 41, 69 and 100 (representative of polymethyl methacrylate) are shown in FIG. 6. It is clearly recognisable that the polyimide signal decreases with increasing number of laser shots, while the polymethyl methacrylate increases, reflecting the layered sample structure.

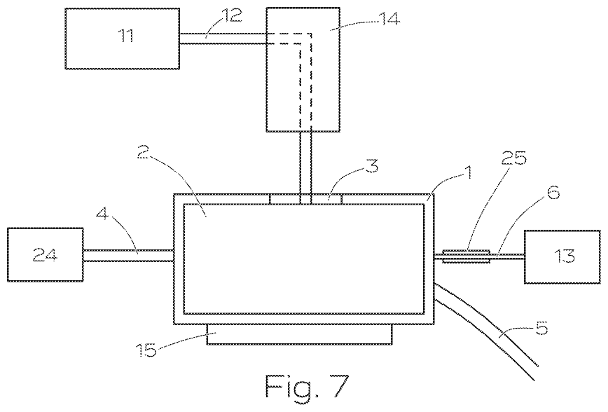

FIG. 7 shows a further embodiment of a system according to the invention. The system shown in FIG. 7 is largely the same as that already shown in FIG. 2. In contrast to the system in FIG. 2, the system in FIG. 7 has a heating device 25 on the second outlet device 6, which is configured as a heating jacket that surrounds the second outlet device 6. By using the heating device 25, the peak shape of the mass spectrometric signals can be improved.

Since the system in FIG. 7 corresponds to the system in FIG. 2 in terms of its other technical features, reference is made to the description of this figure.

### LIST OF REFERENCE SIGNS

1 Housing
2 Sample-accommodating region
3 Window
4 Inlet device
5 First outlet device
6 Second outlet device
7 Inlet opening
8 First outlet opening
9 Second outlet opening
10 Main flow direction
11 Laser apparatus
12 Laser beam
13 Mass spectrometric apparatus
14 Observation apparatus
15 Movement device
16 Cover
17 Seal
18 Fastening screw
19 Inlet tube
20 First outlet tube
21 Second outlet tube
22 Bottom housing part
23 Connector
24 Gas tank
25 Heating device

1. An apparatus for accommodating and for analysing a solid sample material in a spatially and depth-resolved manner, in particular for laser-based chemical analysis, comprising a substantially gas-tight sealed housing (1) with a sample-accommodating region (2) arranged inside the housing (1), wherein the housing (1) comprises a window (3) that is transparent to a laser beam, wherein the apparatus has an inlet device (4) for introducing a fluid flow into the sample-accommodating region (2) and a first outlet device (5) and a second outlet device (6) for discharging the fluid flow loaded with ablated sample material from the sample-accommodating region (2), characterised in that the outlet device (5, 6) are formed in such a way that the ratio between the volume flows of the fluid flow exiting from the first outlet device (5) and volume flows of the fluid flow exiting from the second outlet device (6) is from 100:1 to 5000:1, in particular from 500:1 to 2000:1.

2. The apparatus according to claim 1, characterised in that the inlet device (4) is configured to introduce a fluid flow, in particular a gas, preferably helium, at a flow rate of between 0.5 L/min and 5 L/min, in particular between 0.5 L/min and 2 L/min.

3. The apparatus according to claim 1, characterised in that the housing (1) has an inlet opening (7) to which the inlet device (4) is connected, in that the housing (1) has a first outlet opening (8) to which the first outlet device (5) is connected, and in that the housing (1) has a second outlet opening (9) to which the second outlet device (6) is connected.

4. The apparatus according to claim 3, characterised in that a main flow direction (10) of the fluid flow runs between the inlet opening (7) and the first outlet opening (8), and in that the second outlet opening (9) is arranged at an angle α between 10° and 90°, in particular between 30° and 60°, in relation to the main flow direction (10).

5. The apparatus according to claim 1, characterised in that the sample-accommodating region (2) is circular or drop-shaped.

6. The apparatus according to claim 1, characterised in that the first outlet device (5) has a length L₁ and a flow cross-section Q₁, wherein the length L₁ and a flow cross-section Q₁ are selected such that the first outlet device (5) has substantially no pressure drop, and in that the second outlet device (6) has a length L₂ and a flow cross-section Q₂.

7. The apparatus according to claim 6, characterised in that the flow cross-section Q₂ is between 0.003 and 0.12 mm².

8. The apparatus according to claim 1, characterised in that the housing (1) is arranged on a movement device (15) which is configured to translationally move the housing (1), in particular in three directions which are substantially orthogonal to one another.

9. The apparatus according to claim 1, characterised in that the second outlet device (6) comprises a heating device (25) which is configured to heat the second outlet device (6) at least sectionally.

10. The apparatus according to claim 9, characterised in that the heating device (25) is configured to heat the second outlet device (6) at least sectionally to a temperature of at least 70° C.

11. A system comprising an apparatus according to claim 1 and a laser apparatus (11), wherein the laser apparatus (11) is configured to emit a laser beam (12) onto a solid sample material placed in the sample-accommodating region (2).

12. The system according to claim 11, characterised in that the window (3) has a transmittance of at least 80%, preferably at least 90%, for the wavelength of the laser beam (12).

13. The system according to claim 11, characterised in that the laser apparatus (11) is configured to emit a pulsed monochromatic laser beam (12) with a wavelength of less than 300 nm, and/or in that the laser apparatus (11) is configured to emit a focused laser beam (12) with a minimum beam diameter of less than 500 μm, in particular less than 200 μm.

14. The system according to claim 11, further comprising a mass spectrometric apparatus (13), wherein the mass spectrometric apparatus (13) is configured to ionise sample material in the fluid flow ablated by means of the laser beam (12) by electron impact ionisation and/or by another form of ionisation in a vacuum, wherein the mass spectrometric apparatus (13) is connected to the second outlet device (6) for accommodating the fluid flow.

15. The system according to claim 11, characterised in that an observation apparatus (14) is provided for visual observation of the sample-accommodating region (2) through the window (3), wherein the laser beam (12) can preferably be guided or is guided through an optical system of the observation apparatus (14).

16. The system according to claim 15, characterised in that the observation apparatus (14) comprises an emission analysis apparatus configured to analyse emission radiation generated upon interaction of the laser beam (12) with a solid sample material.

17. The system according to claim 11, further comprising an analysis apparatus, wherein the analysis apparatus is configured to chemically analyse the subject sample material in the fluid flow ablated by the laser beam (12), wherein the analysis apparatus is connected to the first outlet device (5) for accommodating the fluid flow.

18. A method for spatially and depth-resolved analysis of a solid sample material with an apparatus according to claim 1, comprising the following steps:
Placing the sample material in the sample-accommodating region (2),
Ablation of sample material by means of a laser apparatus (11),
Transporting the ablated sample material with a fluid flow flowing from the inlet device (4) via the sample-accommodating region (2) to the first outlet device (5) and to the second outlet device (6), wherein the exiting volume flows of the fluid flow are in a ratio of between 100:1 and 5000:1, in particular between 500:1 and 2000:1, between the first outlet device (5) and the second outlet device (6),
Analysing the ablated sample material exiting together with the fluid flow from the second outlet device (6) with a mass spectrometric apparatus (13) which is configured to ionise the sample material by electron impact ionisation and/or by another form of ionisation in a vacuum.

19. The method according to claim 18, characterised in that the volume flow of the fluid flow flowing in through the inlet device (4) is between 0.5 L/min and 5 L/min, in particular between 0.5 L/min and 2 L/min, at a pressure of between 0.5 bar and 2 bar.

20. The method according to claim 18, characterised in that the volume flow of the fluid flow exiting through the second outlet device (6) is less than 10 mL/min.
